(19) United States
(12) Patent Application Publication
(10) Pub. No.: US 2016/0066310 A1
(43) Pub. Date: Mar. 3, 2016

(54) BASE STATION DEVICE, RADIO TERMINAL DEVICE, NETWORK APPARATUS, AND COMMUNICATION METHOD

(71) Applicant: FUJITSU LIMITED, Kawasaki-shi (JP)

(72) Inventor: Masanori HASHIMOTO, Yokohama (JP)

(73) Assignee: FUJITSU LIMITED, Kawasaki-shi (JP)

(21) Appl. No.: 14/936,156

(22) Filed: Nov. 9, 2015

Related U.S. Application Data
(63) Continuation of application No. PCT/JP2013/064407, filed on May 23, 2013.

(51) Int. Cl. H04W 72/04

(52) U.S. Cl. CPC H04W 72/0406; H04W 88/10

(57) ABSTRACT

A base station device includes: a first controller that connects a first network and a first radio section corresponding to a first communication system each other; and a second controller that connects a second network and a second radio section corresponding to a second communication system each other. When a given condition is met, the second controller transfers a signal received from a radio terminal device via the second radio section to the first network via the first controller.

### CROSS-REFERENCE TO RELATED APPLICATION

This application is a continuation application of International Application No. PCT/JP2013/064407, filed on May 23, 2013 and designating the U.S., the entire contents of which are incorporated herein by reference.

### FIELD

The embodiments discussed herein are related to a base station device, a radio terminal device, a network apparatus, and a communication method.

### BACKGROUND

In recent years, multiple radio access networks employing different communication systems are being introduced into communication systems. As exemplary multiple radio access networks, there are a network corresponding to the wideband code division multiple access (W-CDMA) system and the third generation partnership project long term evolution (LTE) system whose specifications are defined by the third generation partnership project (3GPP) (that can be referred to as “the 3GPP network”) and a network corresponding to the wireless local area network (LAN) system (i.e., wireless LAN). The W-CDMA system and the 3GPP LTE system can be collectively referred to as “the 3GPP system”.

Spreading of radio terminal devices (that can be simply referred to as “terminals” below) is significantly increasing particularly traffic corresponding to the 3GPP system. For this reason, the operator shelters part of the traffic in a communication system in the wireless LAN system.

Specifically, in the communication system illustrated in FIG. 1, because the traffic in a communication route R1 is significantly increasing, the operator shelters the traffic in a communication route R2 and a communication route R3. Furthermore, the operator prepares a communication route R4 in order to reduce the traffic in a 3GPP core network (Core). According to FIG. 1, the communication system includes, as networks, a 3GPP radio access network (RAN), a broadband network (BBNW), a 3GPP core network (Core), a service network of the operator, the Internet, a wireless LAN access point network (WLAN AP-NW), and a WLAN core network (Core). According to FIG. 1, the communication system further includes a user equipment (UP), an evolved Node B (eNB), a Home evolved Node B (HeNB), a serving gateway (SGW), a mobility management entity (MME), a home subscriber server (HSS), and a PDN gateway (PGW). The communication system further includes a wireless access point (WAP), an augmented reality (AR), an authentication authorization accounting (AAA), a dynamic host configuration protocol (DHCP), and a gateway (GW). FIG. 1 is a diagram illustrating an exemplary configuration of a related communication system. The UE represented in FIG. 1 corresponds to a terminal, and the eNB and the HeNB represented in FIG. 1 correspond to base station devices.
Patent Document 1: Japanese Laid-open Patent Publication No. 2006-197536
Patent Document 2: Japanese Laid-open Patent Publication No. 2008-258809
Patent Document 3: International Publication Pamphlet No. WO 2010/109862

The related communication system, however, has a problem in that the flexibility of traffic control is low. For example, when the terminal selects the wireless LAN system, it is not possible to take the traffic into the 3GPP network, which is inconvenient to the operator. In other words, even when the terminal accesses the service network of the operator via the wireless LAN to receive the service from the service network, there is a possibility that it is not possible for the operator to charge the user of the terminal. Under the current circumstance, because the 3GPP system and the wireless LAN system are not compatible, when the systems are switched, there is a possibility that it is not possible for the terminal to receive the service while maintaining the continuity.

### SUMMARY

According to an aspect of the embodiments, a base station device includes: a first controller that connects a first network and a first radio section corresponding to a first communication system each other; and a second controller that connects a second network and a second radio section corresponding to a second communication system each other. When a given condition is met, the second controller transfers a signal received from a radio terminal device via the second radio section to the first network via the first controller.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of a related communication system;

FIG. 2 is a diagram illustrating explanatory main components of a communication system according to a first embodiment;

FIG. 3 is a block diagram representing exemplary main components of a base station according to the first embodiment;

FIG. 4 is a block diagram representing exemplary main components of a terminal according to the first embodiment;

FIG. 5 is a block diagram representing exemplary main components of a network apparatus according to the first embodiment;

FIG. 6 is a block diagram illustrating exemplary base station according to a second embodiment;

FIG. 7 is a block diagram illustrating an exemplary controller of the base station according to the second embodiment;

FIG. 8 is a block diagram illustrating an exemplary terminal according to the second embodiment;

FIG. 9 is a block diagram illustrating an exemplary baseband processing controller of the terminal according to the second embodiment;

FIG. 10 is a block diagram illustrating an exemplary network apparatus according to the second embodiment;

FIG. 11 is a diagram illustrating an exemplary communication system and a third communication route according to the second embodiment;

FIG. 12 is a sequence chart illustrating a procedure of constructing the third communication route;

FIG. 13 is a sequence chart illustrating a procedure of constructing the third communication route;

FIG. 14 is a diagram illustrating a protocol stack corresponding to a user information transfer plane (U-plane);

FIG. 15 is a diagram illustrating a protocol stack corresponding to a call control signal plane (C-plane);

FIG. 16 is a diagram illustrating an exemplary communication system, a first communication route, and a third communication route according to the second embodiment;

FIG. 17 is a diagram for explaining an inter-device handover procedure (variation 1);

FIG. 18 is a diagram for explaining an inter-device handover procedure (variation 1);

FIG. 19 is a diagram illustrating an exemplary communication system, a fifth communication route, and a sixth communication route according to the second embodiment;

FIG. 20 is diagram illustrating an exemplary communication system, a second communication route, and a fourth communication route according to the second embodiment;

FIG. 21 is a diagram for explaining an inter-device handover procedure (variation 3);

FIG. 22 is a diagram for explaining an inter-device handover procedure (variation 3);

FIG. 23 is a diagram illustrating an exemplary hardware configuration of a terminal;

FIG. 24 is a diagram illustrating an exemplary hardware configuration of a base station; and

FIG. 25 is a diagram illustrating an exemplary hardware configuration of a network apparatus.

### DESCRIPTION OF EMBODIMENTS

Preferred embodiments will be explained with reference to accompanying drawings. The embodiments do not limit the base station device, the radio terminal device, the network apparatus, and the communication method that are disclosed herein. Components having the same functions between embodiments are denoted by the same reference numerals and redundant descriptions will not be provided. Furthermore, equivalent processing steps between embodiments are denoted by the same reference numerals and redundant descriptions will not be provided.

### [a] First Embodiment

### Overview of Communication System

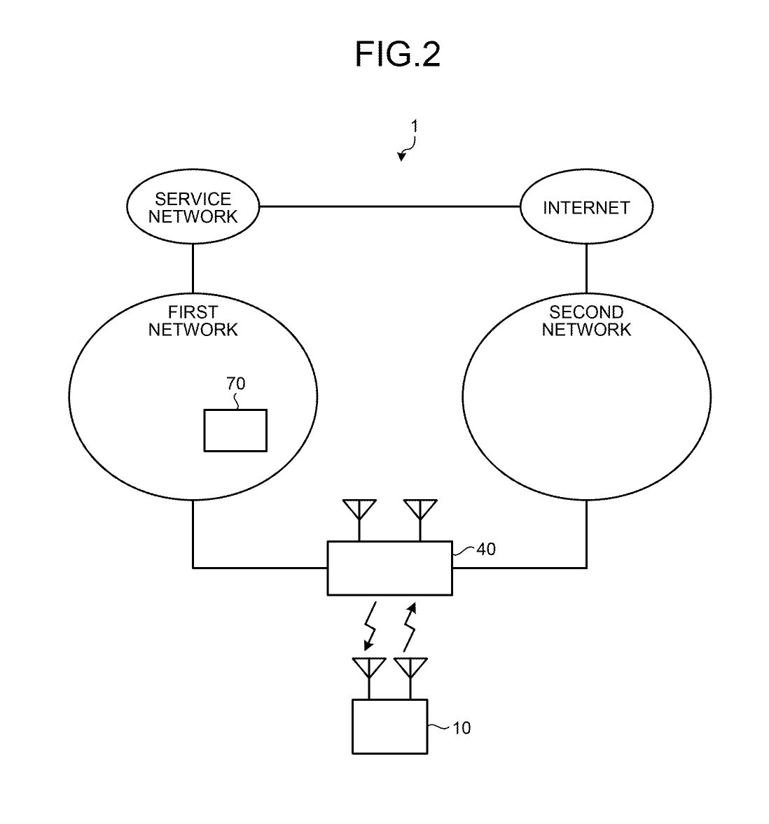

FIG. 2 is a diagram representing explanatory main components of a communication system according to a first embodiment. According to FIG. 2, a communication system 1 includes a terminal 10, a base station device (that can be simply referred to as a “base station” below) 40, and a network apparatus 70. The communication system 1 further includes a first network, a second network, a service network of the operator, and the Internet.

The first network corresponds to a first communication system. The second network corresponds to a second communication system. The service network is connected to the first network and the Internet. The Internet is connected to the service network and the second network.

The terminal 10 is configured to be communicable by using the first communication system and the second communication system. In other words, the terminal 10 is configured to be communicable with the base station 40 by using a first radio section corresponding to the first communication method. Furthermore, the terminal 10 is configured to be communicable with the base station 40 by using a second radio section corresponding to the second communication system.

The base station 40 connects the first radio section to the first network. The communication route formed by this connection state is referred to as a “first communication route”. The base station 40 normally connects the second radio section and the second network. The communication route formed by this connection state is referred to as a “second communication route”.

When a given condition is met, the base station 40 connects the second radio section and the first network to each other. The communication route formed by this connection state is referred to as a “third communication route”. Alternatively, when a given condition is met, the base station 40 connects the first radio section and the second network to each other. The communication route formed by this connection state is referred to as a “fourth communication route”. Accordingly, it is possible to implement flexible traffic control on the first network and the second network.

The base station 40 executes a process of switching only between the radio sections without changing the state of connection between the base station 40 and the network (the first network and the second network) in the communication route constructed once (i.e., inter-device handover). Accordingly, it is possible to implement further flexible traffic control on the first network and the second network. For the terminal 10, the inter-device handover corresponds to handover between systems.

In order for the base station 40 to establish a connection between the second radio section and the first network to each other, the terminal 10 adds a header that is used in the second communication system to a control signal corresponding to the first communication system and sends the control signal added with the header to the base station 40. The control signal contains, for example, a message for establishing a connection. The message for establishing a connection is transmitted to the network apparatus 70.

The network apparatus 70 selects a communication route to be used from among a communication route group including the above-described first to fourth communication routes and notifies the base station 40 of information on the selected communication route.

Exemplary Configuration of Base Station

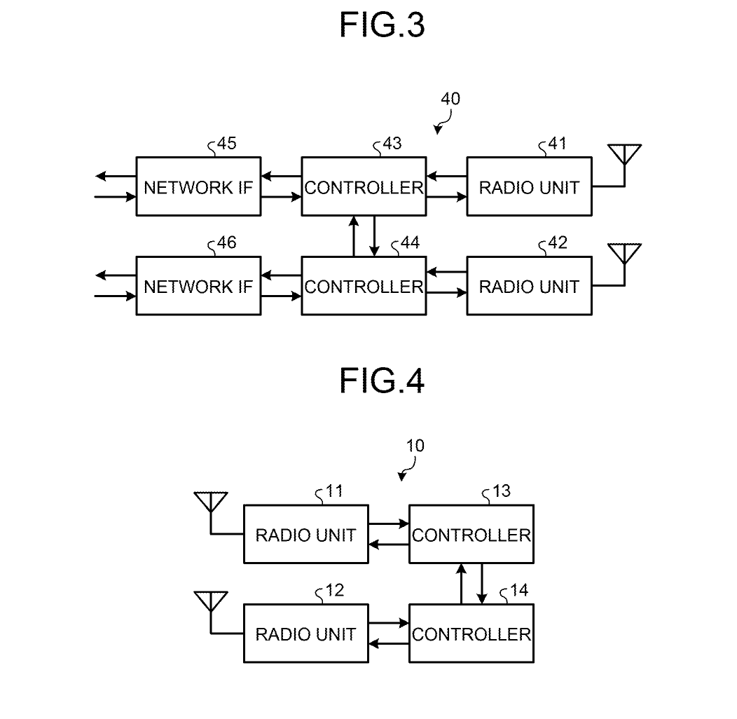

FIG. 3 is a block diagram representing exemplary main components of the base station according to the first embodiment. According to FIG. 3, the base station 40 includes radio units 41 and 42, controllers 43 and 44, and network interfaces (IF) 45 and 46.

The radio unit 41 wirelessly communicates with the terminal 10 by using the first communication system corresponding to the first network system.

The radio unit 42 wirelessly communicates with the terminal 10 by using the second communication system corresponding to the second network system.

The network IF 45 is an interface with the first network and the network IF 46 is an interface with the second network.

The controller 43 is configured to be capable of transmitting/receiving a signal to/from the first network via the network IF 45. The controller 43 is configured to be capable of transmitting/receiving a signal to/from the terminal 10 by using the first radio section and via the radio unit 41.

The controller 43 normally connects the first network and the first radio section corresponding to the first communication system to each other. When a given condition is met, the controller 43 executes a transfer process of transferring a signal, received from the terminal 10 via the radio unit 41, to the second network via the controller 44. When a given condition is met, the controller 43 executes a transfer process of transferring a signal, received from the first network via the network IF 45, to the terminal 10 via the controller 44 by using the second radio section.

The controller 44 is configured to be capable of transmitting/receiving a signal to/from the second network via the network IF 46. The controller 44 is configured to be capable of transmitting/receiving a signal to/from the terminal 10 via the radio unit 42 by using the second radio section.

The controller 44 normally connects the second network and the second radio section corresponding to the second communication system to each other. When a given condition is met, the controller 44 executes a transfer process of transferring a signal, received from the terminal 10 via the radio unit 42, to the first network via the controller 43. When a given condition is met, the controller 44 executes a transfer process of transferring a signal, received from the second network via the network IF 46, to the terminal 10 via the controller 43 by using the first radio section.

Exemplary Configuration of Terminal

FIG. 4 is a block diagram representing exemplary main components of the terminal according to the first embodiment. According to FIG. 4, the terminal 10 includes radio units 11 and 12 and controllers 13 and 14.

The radio unit 11 wirelessly communicates with the base station 40 by using the first communication system corresponding to the first network. In other words, the radio unit 11 communicates with the base station 40 by using the first radio section.

The radio unit 12 wirelessly communicates with the base station 40 by using the second communication system corresponding to the second network. In other words, the radio unit 12 communicates with the base station 40 by using the second radio section.

The controller 13 is configured to be capable of transmitting/receiving a signal from/to the base station 40 via the radio unit 11. When constructing the first communication route or the fourth communication route, the controller 13 generates a control signal corresponding to the first network and adds a header that is used in the first communication system to the control signal, as usual. The controller 13 transmits the control signal added with the header used in the first communication system to the base station 40 via the radio unit 11. Also when constructing the fourth communication route, the terminal 10 performs a process of transmitting the control signal in order to establish a connection with the network apparatus 70 once.

When constructing the above-described third communication route, the controller 13 generates a control signal corresponding to the first network and outputs the generated control signal to the controller 14.

The controller 14 is configured to be capable of transmitting/receiving a signal to/from the base station 40 via the radio unit 12. When constructing the above-described second communication route, the controller 14 normally generates a control signal corresponding to the second network and adds a header that is used in the second communication system to the control signal, as usual. The controller 14 transmits the control signal added with the header used in the second communication system to the base station 40 via the radio unit 12.

Upon receiving a control signal corresponding to the first network from the controller 13, the controller 14 adds a header that is used in the second communication system to the control signal and transmits the control signal added with the header to the base station 40 via the radio unit 12. Upon receiving the control signal, the controller 44 of the base station 40 removes the header. Because the control signal from which the header has been removed corresponds to the first network, the controller 44 then transfers the control signal to the controller 43. Accordingly, it is possible to transmit the control signal corresponding to the first network to the first network by using the second radio section.

Exemplary Configuration of Network Apparatus

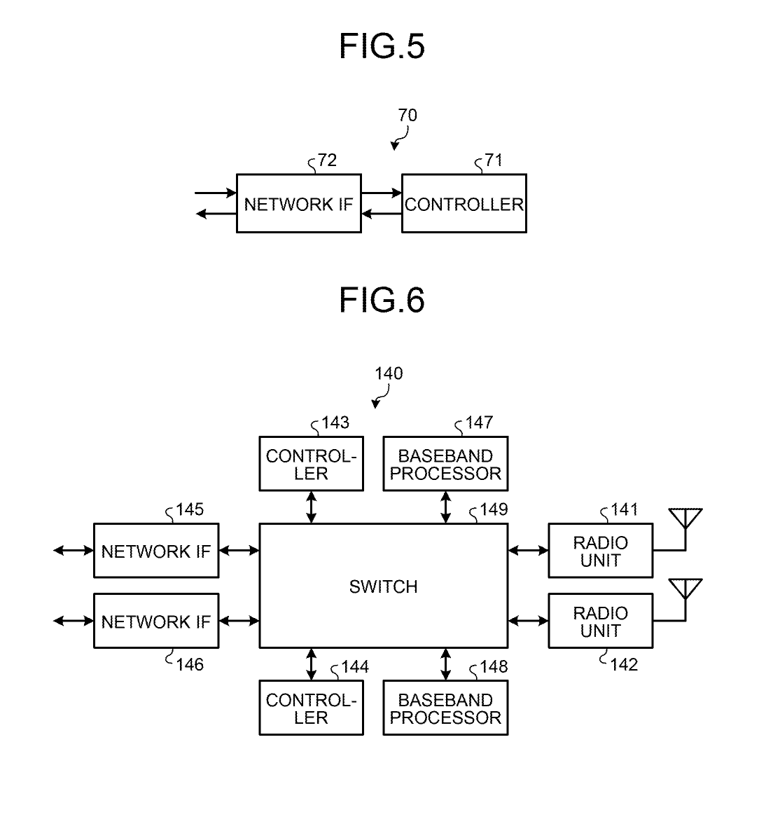

FIG. 5 is a block diagram representing exemplary main components of the network apparatus according to the first embodiment. According to FIG. 5, the network apparatus 70 includes a controller 71 and a network IF 72.

The controller 71 selects a communication route to be used from among a communication route group including the above-described first to fourth communication routes. The controller 71 notifies the base station 40 of information on the selected communication route via the network IF 72.

The network IF 72 is an interface between the network IF 72 and the base station 40.

According to the first embodiment, as described above, in the base station 40, when the given condition is met, the controller 44 executes the transfer process of transferring a signal, received from the terminal 10 via the second radio section, to the first network via the controller 43.

Because the configuration of the base station 40 enables a connection between the second radio section corresponding to the second network and the first network that are normally not connected to each other, it is possible to implement flexible traffic control.

The controller 43 and the controller 44 switch between a first mode in which the above-described transfer is performed and a second mode in which the controller 43 receives a signal from the terminal 10 via the first radio section and transmits the signal, received via the first radio section, to the first network.

This configuration of the base station 40 enables execution of a process for switching only the radio section without changing the state of connection between the base station 40 and the network (the first network and the second network) (i.e., the inter-device handover). Accordingly, it is possible to implement further flexible traffic control on the first network and the second network.

In the terminal 10, the controller 13 generates the control signal corresponding to the first network and the controller 14 adds the header used in the second communication system corresponding to the second network to the control signal generated by the controller 13. The controller 14 transmits the control signal added with the header to the base station 40 by using the second communication system (i.e., the second radio section).

The configuration of the terminal 10 enables transmission of the control signal, transmitted between the controller 13 and the controller 43 corresponding to the first network, via the controller 14 corresponding to the second network, the second radio section, and the controller 44.

According to the above descriptions, each device is provided with two controllers; however, the number of controllers is not limited to this. The two controllers may be integrated into a controller.

### [b] Second Embodiment

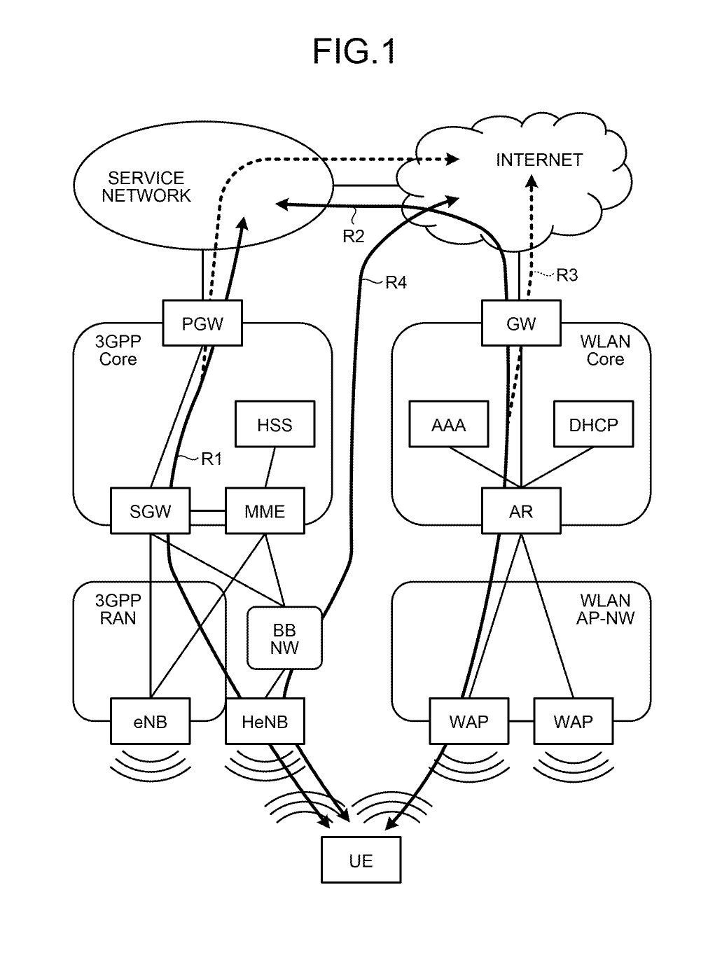

A second embodiment relates to an embodiment in which the first embodiment is further specified. Specifically, according to the second embodiment, a 3GPP network serves as the first network and a wireless LAN serves as the second network. In other words, the basic configuration of the communication system according to the second embodiment is the same as that of the communication system illustrated in FIG. 1. The HeNB and the WAP that are represented in FIG. 1 have been replaced with a single base station as in the case of the communication system 1 according to the first embodiment.

Configuration of Base Station

FIG. 6 is a block diagram illustrating an exemplary base station according to the second embodiment. According to FIG. 6, a base station 140 includes radio units 141 and 142, controller 143 and 144, network IFs 145 and 146, baseband processors 147 and 148, and a switch 149. The radio unit 141, the controller 143, the network IF 145, and the baseband processor 147 are function units corresponding to the 3GPP network (that can be referred to as “3GPP function units” below). The radio unit 142, the controller 144, the network IF 146, and the baseband processor 148 are function units corresponding to the wireless LAN (that can be referred to as “wireless LAN function units” below). The radio units 141 and 142, the controllers 143 and 144, and the network IFs 145 and 146 correspond to the radio units 41 and 42, the controllers 43 and 44, and the network IFs 45 and 46 according to the first embodiment, respectively.

The switch 149 switches the connection relationship between function units connected to the switch 149. The switch 149 switches the connection relationship, for example, in accordance with the communication route to be used.

For example, when the first communication route is to be used, the switch 149 connects the radio unit 141 that is a 3GPP function unit, the controller 143, the network IF 145, and the baseband processor 147. Accordingly, a connection between the first radio section and the 3GPP network is implemented.

When the second communication route is to be used, the switch 149 connects the radio unit 142 that is a wireless LAN function unit, the controller 144, the network IF 146, and the baseband processor 148. Accordingly, a connection between the second radio section and the wireless lAN is implemented.

When the third communication route is to be used, the switch 149 connects the radio unit 142, the baseband processor 148, the controller 144, the controller 143, and the network IF 145. Accordingly, a connection between the second radio section and the 3GPP network is implemented.

When the fourth communication route is to be used, the switch 149 connects the radio unit 141, the baseband processor 147, the controller 143, the controller 144, and the network IF 146. Accordingly, a connection between the first radio section and the wireless LAN is implemented.

The network IF 145 is connected to the switch 149 and the 3GPP network, receives a signal transmitted from the 3GPP network, and outputs the signal to the switch 149. The network IF 145 outputs a signal received via the switch 149 to the 3GPP network.

The network IF 146 is connected to the switch 149 and the wireless LAN, receives a signal transmitted from the wireless LAN, and outputs the signal to the switch 149. The network IF 146 outputs a signal, received via the switch 149, to the wireless LAN.

The controller 143 and the controller 144 control each function unit of the base station 140. The controller 143 mainly controls the 3GPP function units. The controller 144 mainly controls the wireless LAN function units.

The controller 143 and the controller 144 control the connection state of the switch 149 in accordance with the communication route to be used. When the communication route to be used is the third communication route or the fourth communication route, the controller 143 and the controller 144 cooperate to execute a transfer process. The controller 143 and the controller 144 execute a process of switching only the radio section (i.e., inter-device handover) without changing the connection state between the base station 140 and the network (the 3GPP network and the wireless LAN). The controller 143 and the controller 144 will be described in detail below.

The baseband processor 147 and the baseband processor 148 performs various types of processing on a baseband signal, such as media access control (MAC) multiplexing/demultiplexing; synchronization processing; paging processing; and processing of, for example, traffic monitoring.

The radio unit 141 transmits/receives a signal from/to a terminal 110 by using the first radio section. Specifically, the radio unit 141 performs given transmission radio processing (i.e., digital-analog conversion, up-conversion, amplification, etc.) on a signal received via the switch 149 and transmits the processed signal to the terminal 110 via an antenna. The radio unit 141 receives a signal transmitted from the terminal 110, performs given reception radio processing (i.e., amplification, down-conversion, analog-digital conversion, etc.) on the received signal, and outputs the processed signal to the switch 149.

The radio unit 142 transmits/receives a signal to/from the terminal 110 by using the second radio section. Specifically, the radio unit 142 performs given transmission radio processing (i.e., digital-analog conversion, up-conversion, amplification, etc.) on a signal received via the switch 149 and transmits the processed signal to the terminal 110 via an antenna. The radio unit 142 receives a signal transmitted from the terminal 110, performs given reception radio processing (i.e., amplification, down-conversion, analog-digital conversion, etc.), and outputs the processed signal to the switch 149.

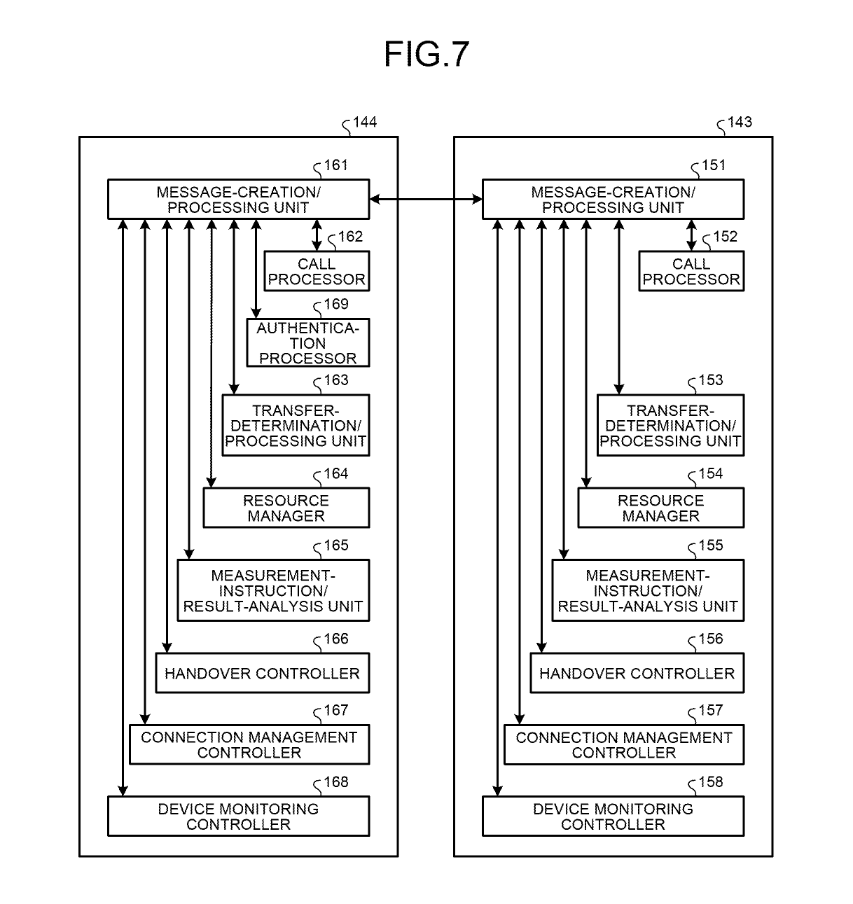

An exemplary configuration of the controller 143 and the controller 144 will be described. FIG. 7 is a block diagram illustrating an exemplary controller of the base station according to the second embodiment. According to FIG. 7, the controller 143 includes a message-creation/processing unit 151, a call processor 152, a transfer-determination/processing unit 153, a resource manager 154, a measurement instruction/result-analysis unit 155, a handover controller 156, a connection management controller 157, and a device monitoring controller 158. The controller 144 includes a message-creation/processing unit 161, a call processor 162, a transfer-determination/processing unit 163, a resource manager 164, a measurement instruction/result-analysis unit 165, a handover controller 166, a connection management controller 167, and a device monitoring controller 168, and an authentication processor 169.

The message-creation/processing unit 151 creates a signal (containing a message) in response to a request from each function unit from the call processor 152 to the device monitoring controller 158 and outputs the signal to the switch 149. A signal (containing a message) that is output from the switch 149 is input to the message-creation/processing unit 151, and the message-creation/processing unit 151 outputs the signal to a corresponding one of the function units from the call processor 152 to the device monitoring controller 158.

When performing a call procedure between the call processor 152 and the terminal 110, the call processor 152 creates various signals (containing a message) for call processing.

The transfer-determination/processing unit 153 executes a process of determining whether to transfer a signal received from the switch 149 and a transfer process.

The resource manager 154 manages the resource used for communications with the terminal device 110.

The measurement instruction/result-analysis unit 155 instructs the message-creation/processing unit 151 to create a signal (containing a message) containing a measurement parameter serving as a reference for the terminal 110 to request a handover, such as a hysteresis value (or an offset value) used by the terminal 110 to measure the communication quality. A signal (containing a message) that is transmitted from the terminal 110 is input to the measurement instruction/result-analysis unit 155 from the message-creation/processing unit 151, and the measurement instruction/result-analysis unit 155 performs processing such as extraction of a measured quality value contained in the signal.

To implement handover, the handover controller 156 instructs the message-creation/processing unit 151 to create a signal (containing a message) that is transmitted to/received from the terminal 110 or the controller 144.

The connection management controller 157 manages the connection state between the connection management controller 157 and the terminal 110, e.g., manages about which signal (containing a message) is transmitted/received between the base station 140 and the terminal 110 that are being connected for communications.

The device monitoring controller 158 monitors the power state of each of the 3GPP function units.

The function units of the controller 144 basically have the same functions as those of the corresponding function units of the above-described controller 143. The controller 144 includes the authentication processor 169. The authentication processor 169 executes an authentication procedure between the authentication processor 169 and the terminal 110.

Authentication processing on the side of the 3GPP network is performed by a MME.

Exemplary Configuration of Terminal

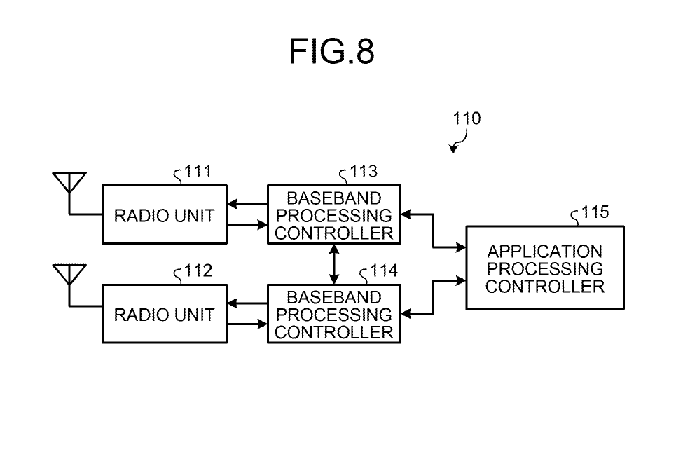

FIG. 8 is a block diagram illustrating an exemplary terminal according to the second embodiment. According to FIG. 8, the terminal 110 includes radio units 111 and 112, baseband processing controllers 113 and 114, and an application processing controller 115. The radio unit 111 and the baseband processing controller 113 are function units corresponding to the 3GPP network (that can be referred to as “3GPP function units” below). The radio unit 112 and the baseband processing controller 114 are function units corresponding to the wireless LAN (that can be referred to as “wireless LAN function units” below). The radio units 111 and 112 and the baseband processing controllers 113 and 114 correspond to the radio units 11 and 12 and the controllers 13 and 14 according to the first embodiment, respectively.

The radio unit 111 transmits/receives a signal to/from the base station 140 by using the first radio section. Specifically, the radio unit 111 performs given transmission radio processing (i.e., digital-analog conversion, up-conversion, amplification, etc.) on a signal received from the baseband processing controller 113 and transmits the processed signal to the base station 140 via the antenna. The radio unit 111 also receives a signal transmitted from the base station 140, performs given reception radio processing (i.e., amplification, down-conversion, analog-digital conversion, etc.) on the received signal, and outputs the processed signal to the baseband processing controller 113.

The radio unit 112 transmits/receives a signal to/from the base station 140 by using the second radio section. Specifically, the radio unit 112 performs given transmission radio processing (i.e., digital-analog conversion, up-conversion, amplification, etc.) on a signal received from the baseband processing controller 114 and transmits the processed signal to the base station 140 via the antenna. The radio unit 112 receives a signal transmitted from the base station 140, performs given reception radio processing (i.e., amplification, down-conversion, analog-digital conversion, etc.) on the received signal, and outputs the processed signal to the baseband processing controller 114.

The baseband processing controller 113 and the baseband processing controller 114 perform, for example, processing for creating a signal (containing a message) and processing on the data. The baseband processing controller 113 and the baseband processing controller 114 will be described in detail below.

The application processing controller 115 receives received data that is output from the baseband processing controller 113 and the baseband processing controller 114 and performs various types of application processing. The application processing controller 115 outputs transmission data generated by the application to the baseband processing controller 113 or the baseband processing controller 114.

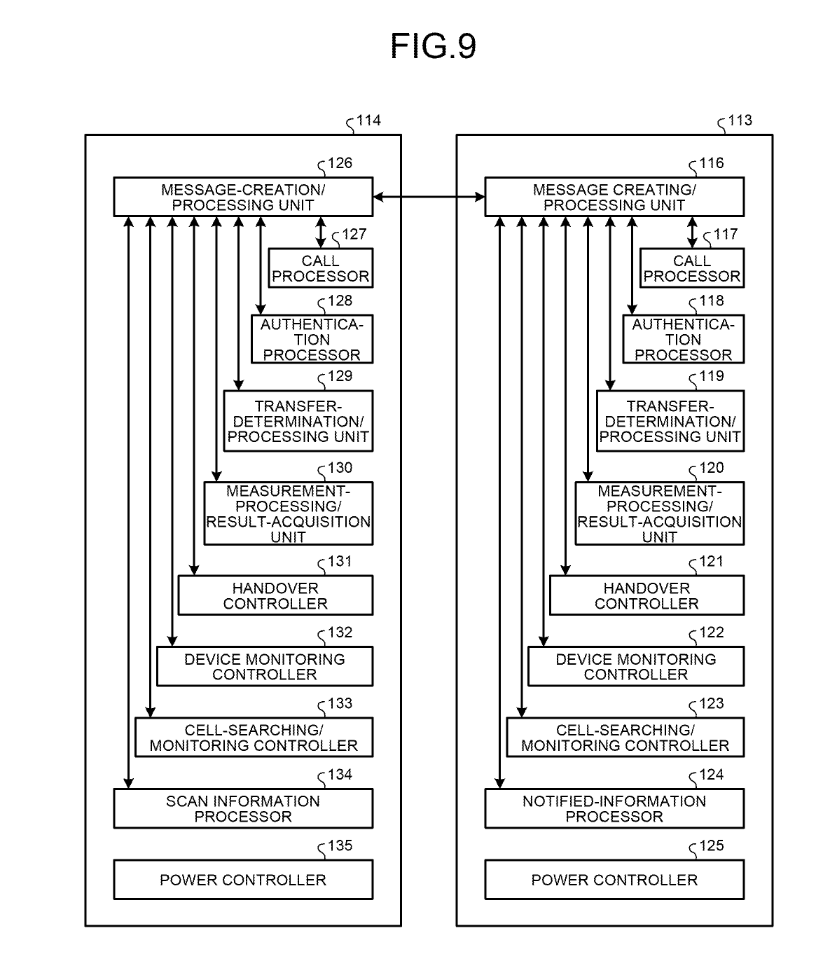

FIG. 9 is a block diagram illustrating an exemplary baseband processing controller of the terminal according to the second embodiment. According to FIG. 9, the baseband processing controller 113 includes a message-creation/processing unit 116, a call processor 117, an authentication processor 118, a transfer-determination/processing unit 119, a measurement-processing/result-acquisition unit 120, a handover controller 121, a device monitoring controller 122, a cell-searching/monitoring controller 123, a notified information processor 124, and a power controller 125. The baseband processing controller 114 includes a message-creation/processing unit 126, a call processor 127, an authentication processor 128, a transfer-determination/processing unit 129, a measurement-processing/result-acquisition unit 130, a handover controller 131, a device monitoring controller 132, a cell-searching/monitoring controller 133, a scan information processor 134, and a power controller 135.

The message-creation/processing unit 116 creates a signal (containing a message) in response to a request from each function unit from the call processor 117 to the notified-information processor 124 and outputs the signal to the radio unit 111.

The call processor 117 requests the message-creation/processing unit 116 to create a signal (containing a message) for executing a call procedure between the call processor 117 and the MME. A signal (containing a message) output from the MME is input to call processor 117 from the message-creation/processing unit 116, and the call processor performs processing for the call procedure.

The authentication processor 118 requests the message creating/processing unit 116 to create a signal (containing a message) for executing an authentication procedure between the authentication processor 118 and the MME. A signal (containing a message) output from the MME is input to the authentication processor 118, and the authentication processor 118 performs processing for the authentication procedure.

The transfer-determination/processing unit 119 executes a process of determining whether to transfer a signal, received from the message-creation/processing unit 116, to the baseband processing controller 114 and the transfer process.

The measurement-processing/result-acquisition unit 120 performs measurement of the communication quality on each cell, etc. For example, the measurement-processing/result-acquisition unit 120 measures, for example, a received power or a desired-to-undesired signal power ratio (such as SIR or SINR) corresponding to a known signal that is transmitted from another base station corresponding to the base station 140 and the 3GPP network. For example, the call processor 117 or the measurement-processing/result-acquisition unit 120 holds terminal identifiers transmitted from the MME via the base station 140.

The handover controller 121 requests the message-creation/processing unit 116 to create a signal (containing a message) that is transmitted for handover processing. A signal (containing a message) received from the base station 140 is input to the handover controller 121 from the message-creation/processing unit 116 and the handover controller 121 performs various types of processing for handover.

The device monitoring controller 122 monitors whether each of the 3GPP function units is running normally.

The cell-searching/monitoring controller 123 performs cell search processing. For example, the cell-searching/monitoring controller 123 searches for a cell with the smallest pass loss at a given interval at the power-up of the terminal 110.

The notified-information processor 124 performs various types of processing on notified information received from the base station 140 to which the terminal 110 is connected. The notified-information processor 124, for example, outputs adjacent cell information contained in the notified information (the identifier of each cell or the identifier of each base station 140) to the measurement-processing/result-acquisition unit 120.

The power controller 125 controls the power of each of the 3GPP function units.

The function units of the baseband processing controller 114 basically have the same functions as those of the corresponding function units of the above-described baseband processing controller 113. As in the case where the authentication processor 128 takes the authentication procedure between the authentication processor 128 and the base station 140, the unit with which processing is performed differ between the function units of the baseband processing controller 113 and the function units of the baseband processing controller 114.

Exemplary Configuration of Network Apparatus

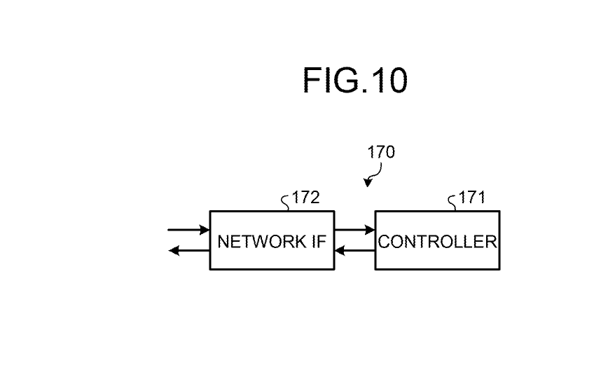

FIG. 10 is a block diagram illustrating an exemplary network apparatus according to the second embodiment. As illustrated in FIG. 10, a network apparatus 170 includes a controller 171 and a network IF 172. The network apparatus 170 corresponds to the network apparatus 70 according to the first embodiment. The network apparatus 170 is also equivalent to the MME. The controller 171 and a network IF 172 correspond to the controller 71 and the network IF 72 according to the first embodiment, respectively.

The controller 171 executes a call procedure between the controller 171 and the terminal 110. The controller 171 executes the authentication procedure on the terminal 110 that is taken between the controller 171 and the terminal 110. Furthermore, the controller 171 selects a communication route to be used from among a communication route group including the first to fourth communication routes. The controller 171 notifies the base station 140 of information on the selected communication route via the network IF 172.

Processing Operations of Communication System

Processing operations of the communication system having the above-described configuration will be described.

Procedure of Constructing Third Communication Route

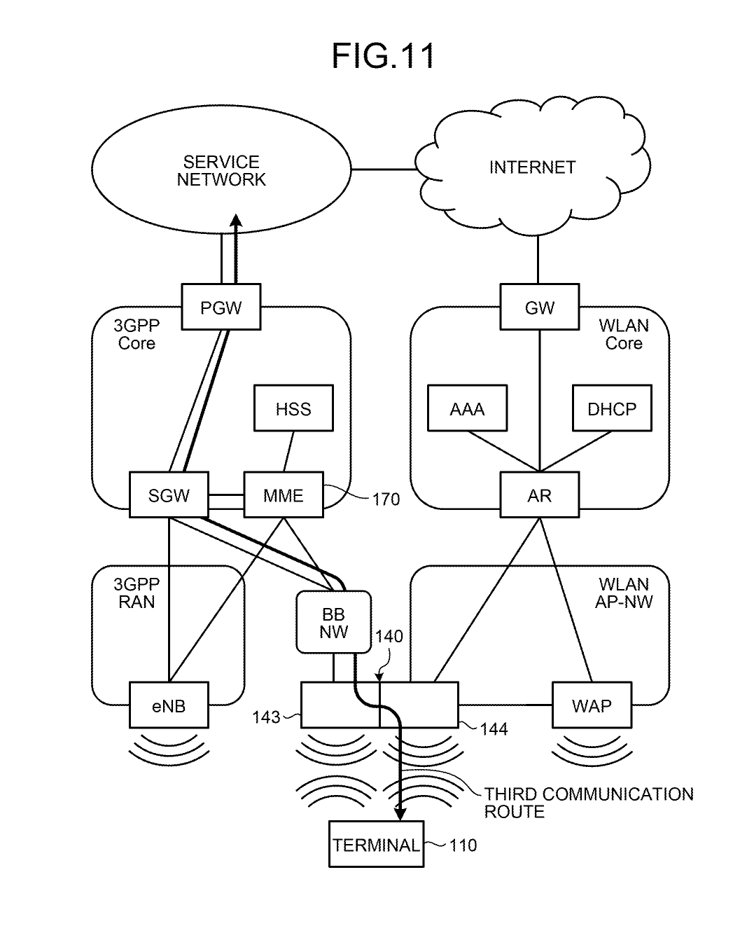

FIG. 11 is a diagram illustrating an exemplary communication system and a third communications route according to the second embodiment. As illustrated in FIG. 11, in the third communication route, the terminal 110, the controller 144 and the controller 143 of the base station 140, a BBNW, a SGW, and a PGW are connected in the order in which they appear in this sentence.

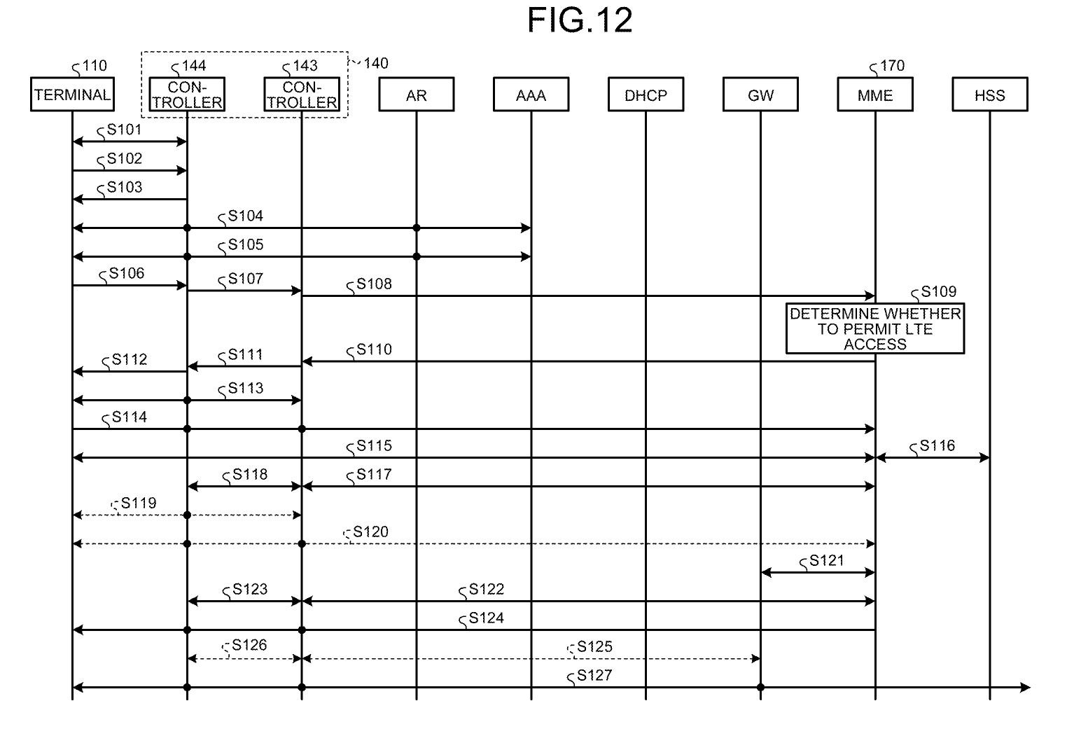

FIG. 12 is a sequence chart illustrating a procedure of constructing the third communication route. FIG. 12 illustrates, as a procedure for constructing the third communication route, a procedure for the terminal 110 to try an access in the second radio section.

The baseband processing controller 114 of the terminal 110 scans a beacon that is transmitted from the base station 140 in a frequency band that can be used by the wireless LAN system (step S101). The scan method may be a method in which the terminal 110 automatically scans a beacon transmitted from the base station 140 (passive scan) or a method of receiving a beacon transmitted from the base station 140 in response to a request issued from the terminal 110 to the base station 140 (active scan).

On the basis of the received beacon, the baseband processing controller 114 of the terminal 110 transmits an authentication request to the base station 140 by using the second radio section (step S102).

In response to the received authentication request, the controller 144 of the base station 140 notifies the terminal 110 of the authentication method by using the second radio section (step S103).

On the basis of the notified authentication method, the baseband processing controller 114 of the terminal 110 transmits the authentication request to the base station 140 by using the second radio section and, based on the received authentication request, the controller 144 of the base station 140 accesses the AAA (step S104).

The AAA then transmits the authentication check containing information on the terminal 110 to the terminal 110 via the controller 144 of the base station 140 (step S105). The information on the terminal 110 contains information representing whether the terminal 110 is accessible by the LTE system (that can be referred to as “LTE accessible/non-accessible information” below). Accordingly, the base station 140 and the terminal 110 can know whether the terminal 110 is a terminal accessible by the LTE system.

Because the terminal 110 is a terminal accessible by the LTE system, the baseband processing controller 114 of the terminal 110 transmits an association establishment request containing an LTE access request to the base station 140 by using the second radio section (step S106). The LTE access request may contain the details of the access.

The controller 144 of the base station 140 then outputs a LTE access request, contained in the received association establishment request, to the controller 143 (step S107).

The controller 143 of the base station 140 transmits the received LTE access request to the network apparatus 170 (the MME 170 in FIG. 11) (step S108). The LTE access request transmitted here is transmitted in order for the network apparatus 170 to determine whether to establish the third communication route as the communication route of the terminal 110.

Upon receiving the LTE access request, the controller 171 of the network apparatus 170 determines whether to permit the LTE access by the terminal 110 (step S109). The determination is made, for example, based on the state of the LTE network (such as the level of congestion, i.e., the level of the amount of traffic) or the details of the access.

The controller 171 of the network apparatus 170 transmits a response containing the determination result to the base station 140 (step S110).

Upon receiving the response, the controller 143 of the base station 140 outputs the determination result contained in the response to the controller 144 (step S111).

The controller 144 of the base station 140 transmits an association establishment response containing the received determination result to the terminal 110 by using the second radio section (step S112). When the determination result contained in the association establishment response represents permission, the terminal 110 executes an LTE access using the second radio section. It is assumed that the determination result represents permission.

Upon receiving the association establishment response containing the determination result representing permission via the baseband processing controller 114, the baseband processing controller 113 of the terminal 110 establishes a radio resource control connection (RRC connection) via the baseband processing controller 114 and the second radio section (step S113). The baseband processing controller 113 generates a control signal used for establishing the RRC connection and corresponding to the LTE system, and the baseband processing controller 114 adds a header, corresponding to the wireless LAN system, to the control signal and transmits the signal to the base station 140. Accordingly, the control signal is transmitted to the controller 143 of the base station 140. Accordingly, the baseband processing controller 113 of the terminal 110 and the controller 143 of the base station 140 can execute a RRC connection establishment procedure.

The following procedure is basically the same as the LET Attach procedure in which an internet protocol (IP) address is allocated to the terminal 110 so that and the terminal 110 can transmit/receive IP packets to/from an IP network other than the PGW.

In other words, the terminal 110 transmits a service request containing information on the terminal 110 (such as the ID) to the network apparatus 170 via the second radio section and the base station 140 (step S114).

The terminal 110 and the network apparatus 170 execute an authentication procedure (step S115). The network apparatus 170 acquires subscriber information on the terminal 110 from the HSS (step S116).

The network apparatus 170 then transmits security information for encrypting communications to the base station 140 (step S117). The controller 143 of the base station 140 outputs the received security information to the controller 144 (step S118).

Encryption and integrity protection are started in the section between the terminal 110 and the controller 144 and the controller 143 of the base station 140 (step S119). Furthermore, encryption and integrity protection are started in the section between the terminal 110, the controller 143 and the controller 144 of the base station 140, and the network apparatus 170 (step S120).

The network apparatus 170 then instructs the GW (the SGW and the PGW) to construct a bearer for the terminal 110 (corresponding to the communication route) (step S121).

The network apparatus 170 further instructs the base station 140 to construct a bearer for the terminal 110 (step S122). The controller 143 of the base station 140 having received the instruction outputs the instruction to the controller 144 (step S123). Accordingly, the bearer for the terminal 110 is constructed between the network apparatus 170 and the controller 143 and between the controller 143 and the controller 144. Accordingly, a communication preparation completes.

The network apparatus 170 then transmits service acceptance to the terminal 110 (step S124). This service acceptance contains the IP address for the terminal 110 allocated by the PGW. The terminal 110 performs communications using the IP address.

A GTP-U tunnel is established between the base station 140 and the GW and between the controller 143 and the controller 144 (steps S125 and S126). This enables transfer of IP packets via the third communication route.

The terminal 110 transmits/receives IP packets to/from a network outside the PGW (step S127).

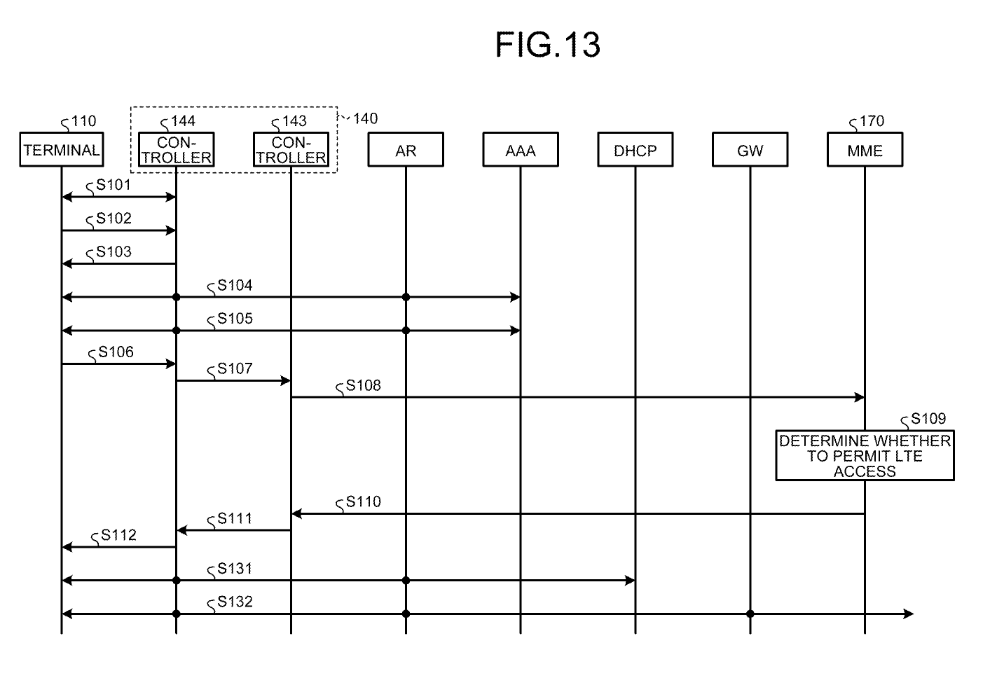

FIG. 13 is a sequence chart illustrating a procedure of constructing the third communication route. FIG. 13 illustrates the case where it is determined at step S109 not to permit an LTE access.

Upon receiving an association establishment response containing the determination result representing non-permission, the baseband processing controller 114 of the terminal 110 requests the DHCP server for the IP address by using a broadcast packet, and the DHCP server transmits the IP address to the terminal 110 in response to the request (step S131).

The terminal 110 transmits/receives an IP packet to/from the IP network outside the GW (step S132).

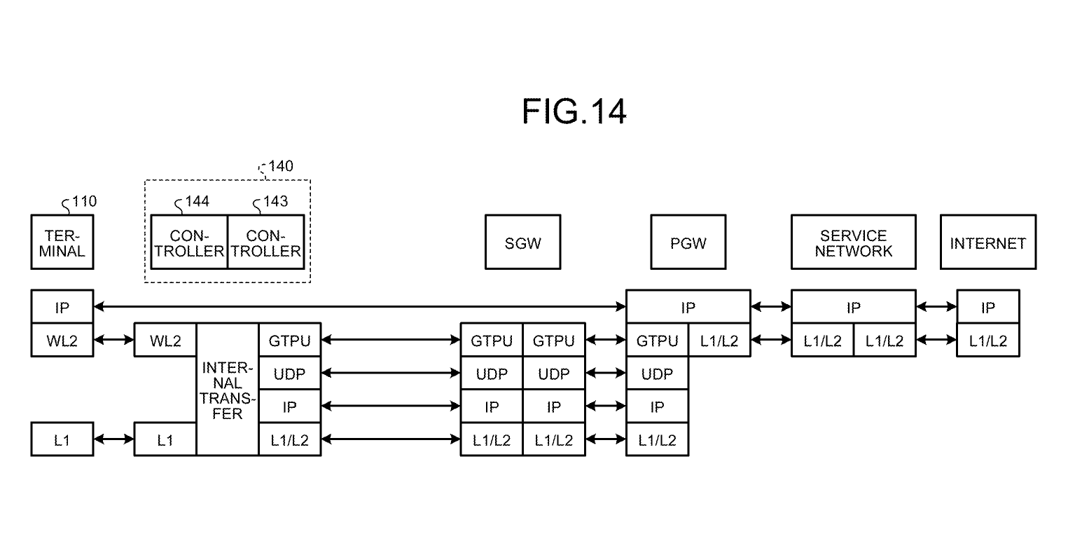

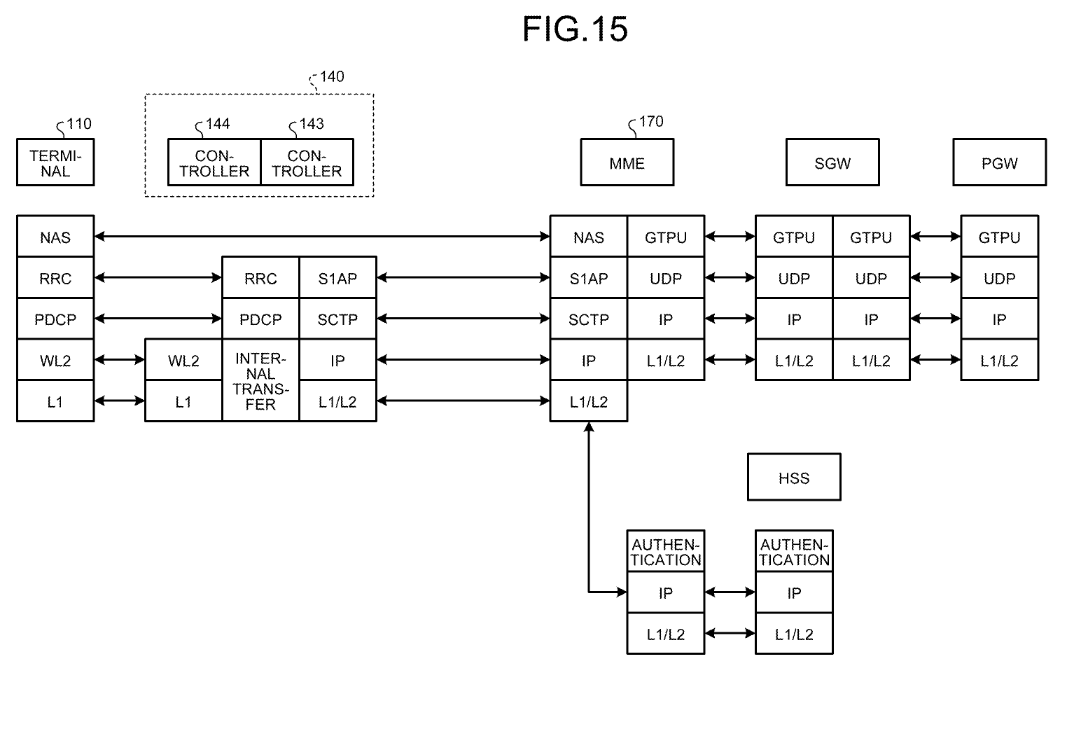

FIGS. 14 and 15 each illustrate a protocol stack corresponding to the procedure for constructing the third communication route described above. FIG. 14 is a diagram illustrating the protocol struck corresponding to a user information transfer plane (U-plane). FIG. 15 is a diagram illustrating the protocol struck corresponding to a call control signal plane (C-plane).

Inter-Device Handover Procedure (Variation 1)

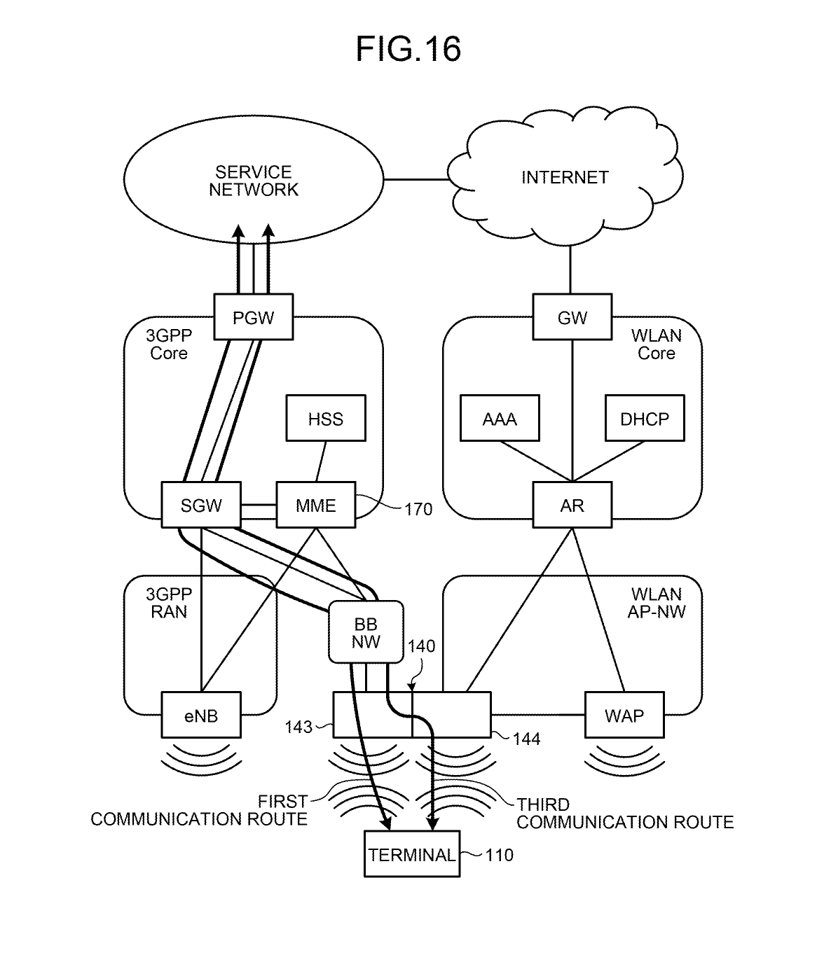

FIG. 16 is a diagram illustrating an exemplary communication system, the first communication route, and the third communication route according to the second embodiment. As illustrated in FIG. 16, in the first communication route, the terminal 110, the controller 143 of the base station 140, the BBNW, the SGW, and the PGW are connected in the order in which they appear in this sentence.

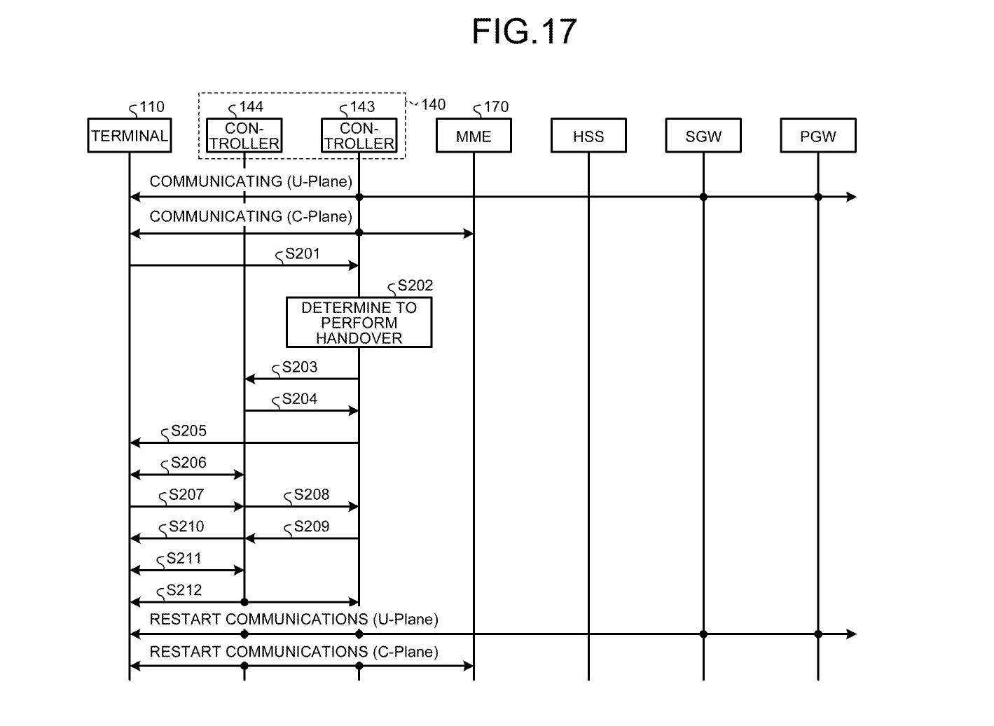

FIG. 17 is a diagram for explaining an inter-device handover procedure (variation 1). FIG. 17 particularly illustrates a procedure on inter-device handover from the first communication route to the third communication route. In other words, according to FIG. 17, the first communication route has been already established and the U-plane uses the first communication route. The C-plane uses the LTE route, i.e., the route between the terminal 110, the controller 143 of the base station 140, the BBNW, and the MME. The first communication route may contain the LTE route.

When a condition that is set is met, the terminal 110 transmits a measurement report to the controller 143 of the base station 140 by using the first radio section (step S201). The set condition may be, for example, a condition that, according to the measurement, the radio environment of the second radio section is better than that of the first radio section. The measurement report triggers the controller 143 of the base station 140 to determine to perform handover.

On the basis of the contents of the received measurement report and the amount of traffic of the network, the controller 143 of the base station 140 determines (judges) whether to perform handover (step S202). It is here assumed that the controller 143 determines to perform handover.

The controller 143 notifies the controller 144 that the controller 143 has determined to perform handover (step S203).

The controller 144 prepares for handover in response to the notification and, upon completing the preparation, outputs a response to the notification to the controller 143 (step S204).

The controller 143 transmits a handover instruction to the terminal 110 via the first radio section (step S205).

Upon receiving the handover instruction, the baseband processing controller 113 of the terminal 110 transfers the handover instruction to the baseband processing controller 114. The baseband processing controller 114 scans a beacon transmitted from the base station 140 in the frequency band usable in the wireless LAN system (step S206)

In accordance with the received beacon, the baseband processing controller 114 then transmits an authentication request to the controller 144 of the base station 140 by using the second radio section (step S207).

The controller 144 of the base station 140 then outputs the received authentication request to the controller 143 (step S208).

In response to the received authentication request, the controller 143 outputs an authentication method to the controller 144 (step S209).

The controller 144 then notifies the terminal 110 of the received authentication method by using the second radio section (step S210).

The base band processing controller 114 of the terminal 110 and the controller 144 of the base station 140 establish an association (step S211).

The baseband processing controller 113 of the terminal 110 and the controller 143 of the base station 140 re-establish an RRC connection via the baseband processing controller 114 and the controller 144 (step S212).

In this manner, it is possible to switch from the first communication route to the third communication route.

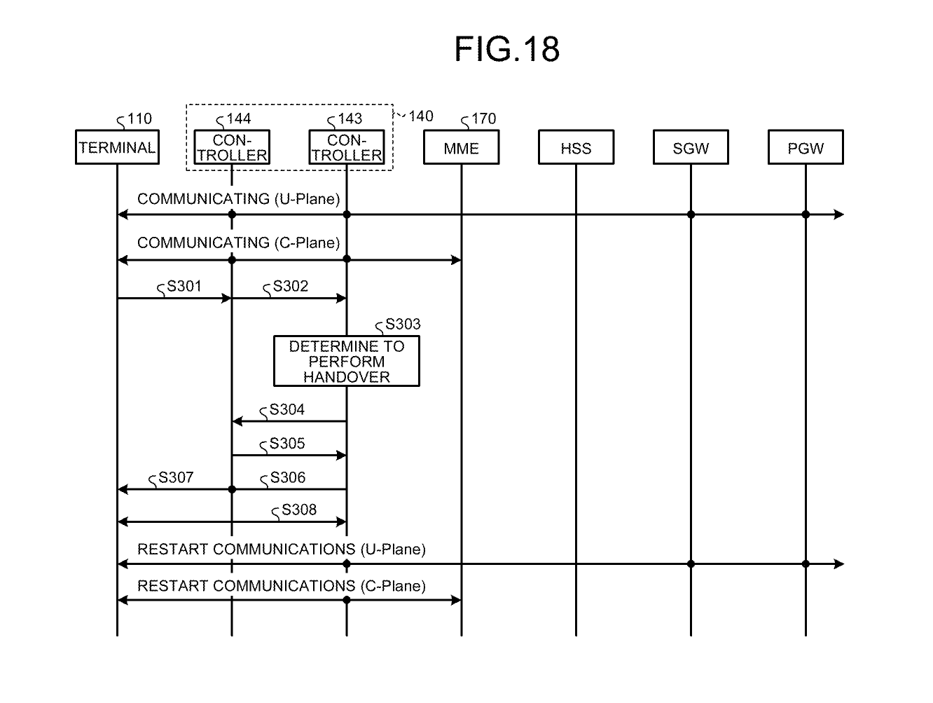

FIG. 18 is a diagram for explaining an inter-device handover procedure (variation 1). FIG. 18 particularly illustrates a procedure on inter-device handover from the third communication route to the first communication route. According to FIG. 18, the third communication route has been established and the U-plane uses the third communication route. The C-plane uses the route between the terminal 110, the controller 144 and the controller 143 of the base station 140, the BBNW, and the MME. The third communication route may contain this route.

When a set condition is met, the terminal 110 transmits a measurement report to the controller 144 of the base station 140 by using the second radio section (step S301).

The controller 144 of the base station 140 outputs the received measurement report to the controller 143 (step S302).

On the basis of the contents of the received measurement report and the amount of traffic of the network, the controller 143 of the base station 140 determines (judges) whether to perform handover (step S303). It is here assumed that the controller 143 determines to perform handover.

The controller 143 notifies the controller 144 that the controller 143 has determined to perform handover (step S304).

The controller 144 prepares for handover in response to the notification (i.e., preparation for disconnecting the third communication route) and, upon completing the preparation, outputs a response to the notification to the controller 143 (step S305).

The controller 143 outputs a handover instruction to the controller 144 (step S306) and the controller 144 transmits the received handover instruction to the terminal 110 via the second radio section (step S307).

The baseband processing controller 113 of the terminal 110 and the controller 143 of the base station 140 then re-establish an RRC connection (step S308).

In this manner, it is possible to switch from the third communication route to the first communication route.

Inter-Device Handover Procedure (Variation 2)

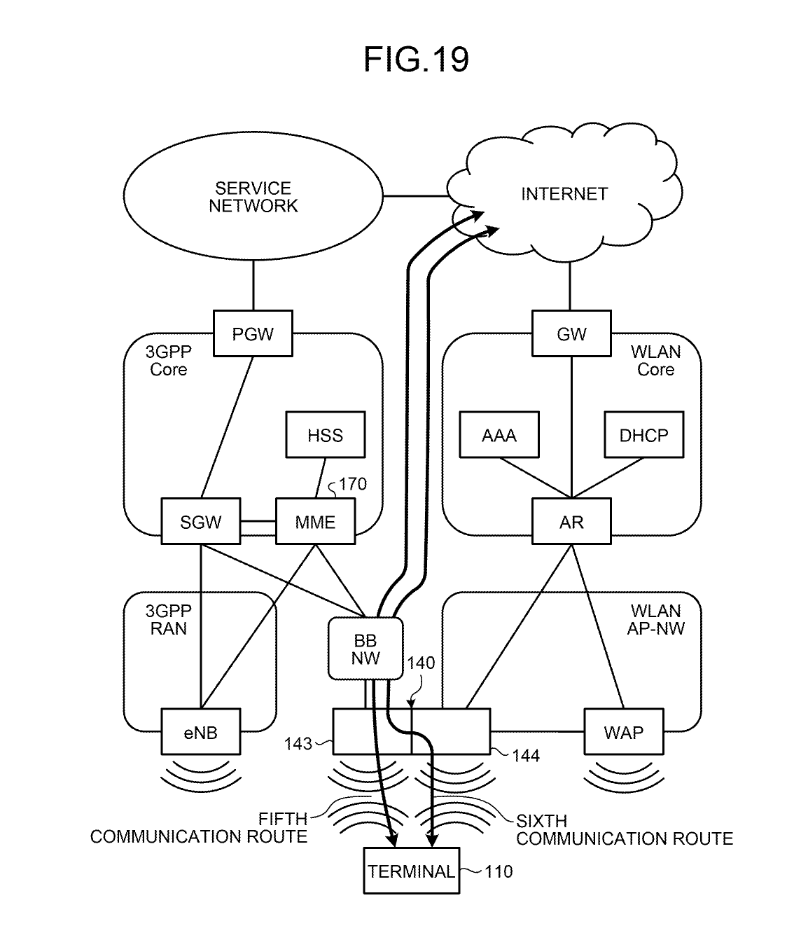

FIG. 19 is a diagram illustrating an exemplary communication system, a fifth communication route, and a sixth communication route according to the second embodiment. As illustrated in FIG. 19, in the fifth communication route, the terminal 110, the controller 143 of the base station 140, the BBNW, and the Internet are connected in the order in which they appear in this sentence. In the sixth communication route, the terminal 110, the controller 144 and the controller 143 of the base station 140, the BBNW, and the Internet are connected in the order in which they appear in this sentence.

The fifth communication route and the sixth communication route may be classified into the first communication route and the third communication route, respectively. In other words, the first communication route and the third communication route are only different from the fifth communication route and the sixth communication route in the communication route of the network of the base station 140 and are common in the switching procedure itself. Accordingly, it is possible to switch from the fifth communication route to the sixth communication route by using the procedure illustrated in FIG. 17. It is also possible to switch from the sixth communication route to the fifth communication route by using the procedure illustrated in FIG. 18.

Inter-Device Handover Procedure (Variation 3)

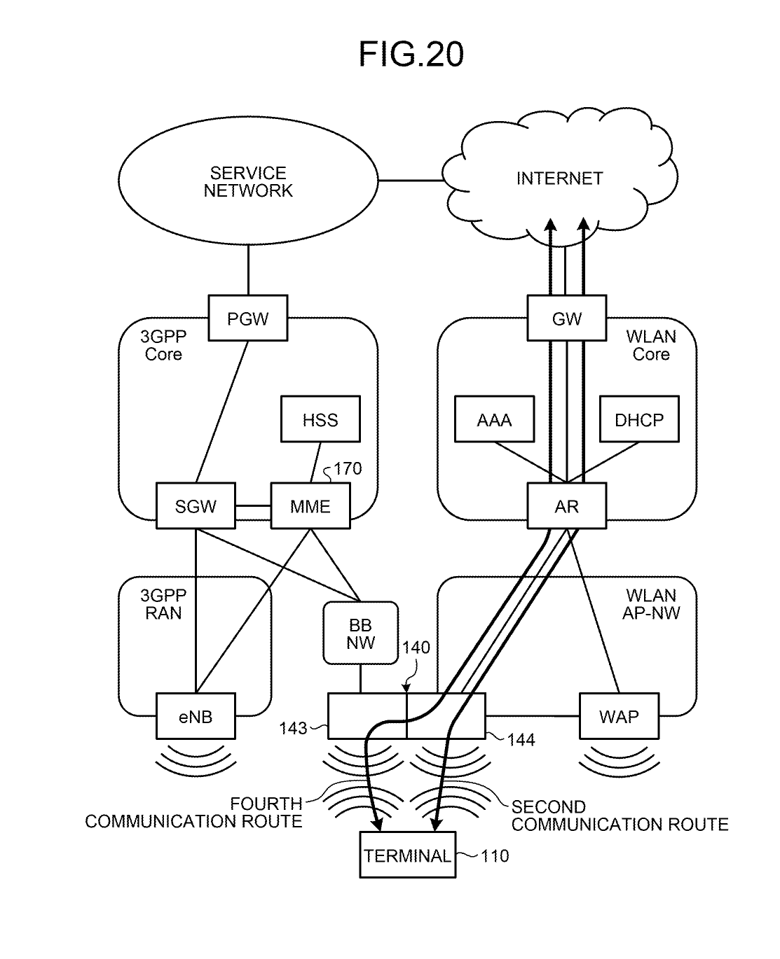

FIG. 20 is a diagram illustrating an exemplary communication system, the second communication route, and the fourth communication route according to the second embodiment. As illustrated in FIG. 20, in the second communication route, the terminal 110, the controller 144 of the base station 140, the AR, GW, and the Internet are connected in the order in which they appear in this sentence. In the fourth communication route, the terminal 110, the controller 143 and the controller 144 of the base station 140, the AR, the GW, and the Internet are connected in the order in which they appear in this sentence.

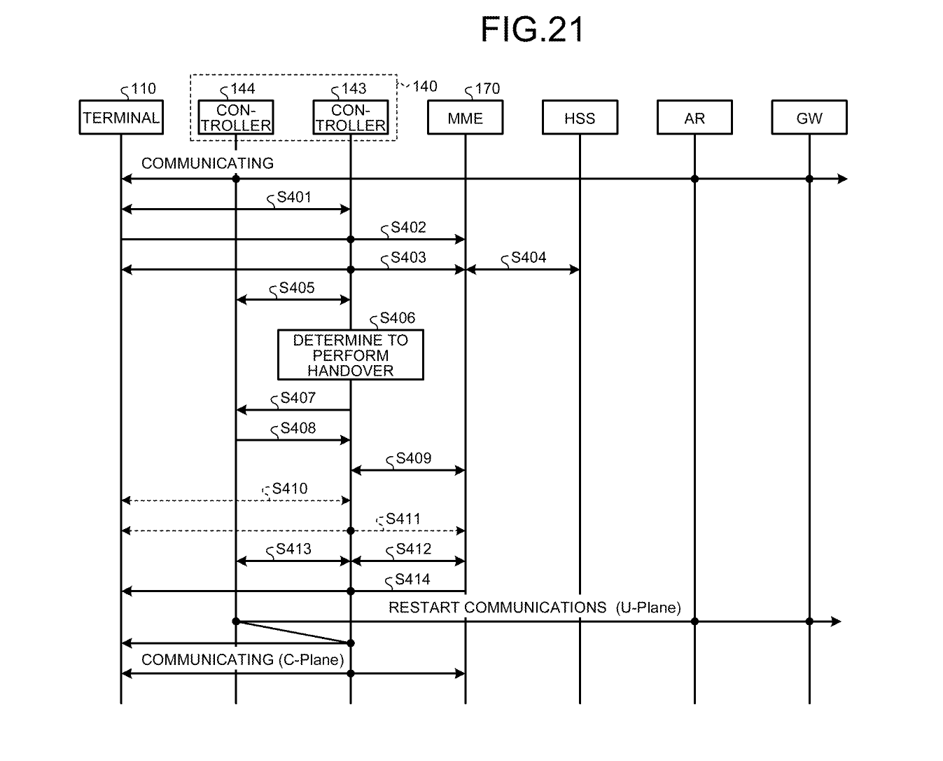

FIG. 21 is a diagram for explaining an inter-device handover procedure (variation 3). FIG. 21 particularly illustrates the procedure on inter-device handover from the second communication route to the fourth communication route. In other words, according to FIG. 21, the second communication route has been established and the U-plane uses the second communication route. There is no C-plane.

When a set condition is met, the baseband processing controller 113 of the terminal 110 establishes a RRC connection between the baseband processing controller 113 and the controller 143 of the base station 140 (step S401). The set condition may be, for example, a condition that, according to the measurement, the radio environment of the first radio section is better than that of the second radio section.

The terminal 110 transmits a service request containing information on the terminal 110 (such as the ID) to the network apparatus 170 via the first radio section and the controller 143 of the base station 140 (step S402).

The terminal 110 and the network apparatus 170 then executes an authentication procedure (step S403). The network apparatus 170 acquires subscriber information on the terminal 110 from the HSS (step S404).

The controller 143 of the base station 140 inquires the controller 144 of whether the terminal 110 specified from the information on the RRC connection is being connected to the controller 144 via the second radio section (step S405). Here, the terminal 110 is connected to the controller 144 via the second radio section.

The controller 143 of the base station 140 then determines (judges) whether to perform handover with respect to the terminal 110 (step S406). It is here assumed that the controller 143 determines to perform handover.

The controller 143 notifies the controller 144 that the controller 143 has determined to perform handover (step S407).

The controller 144 prepares for handover in response to the notification and, upon completing the preparation, outputs a response to the notification to the controller 143 (step S408).

The network apparatus 170 then transmits security information for encrypting communications to the controller 143 of the base station 140 (step S409).

Encryption and integrity protection are started in the section between the terminal 110 and the controller 143 of the base station 140 (step S410). Furthermore, encryption and integrity protection are started in the section between the terminal 110, the controller 143 of the base station 140, and the network apparatus 170 (step S411).

The network apparatus 170 then instructs the controller 143 of the base station 140 to construct a bearer (corresponding to a communication route) for the terminal 110 (step S412). The controller 143 of the base station 140 having received the instruction outputs the instruction to the controller 144 (step S413). Accordingly, a bearer for the terminal 110 is constructed between the network apparatus 170 and the controller 143 and between the controller 143 and the controller 144.

The network apparatus 170 then transmits service acceptance to the terminal 110 via the controller 143 of the base station 140 and the first radio section (step S414).

In this manner, it is possible to switch from the second communication route to the fourth communication route. For the C-plane, the route connecting the terminal 110, the controller 143 of the base station 140, and the network apparatus 170 is used.

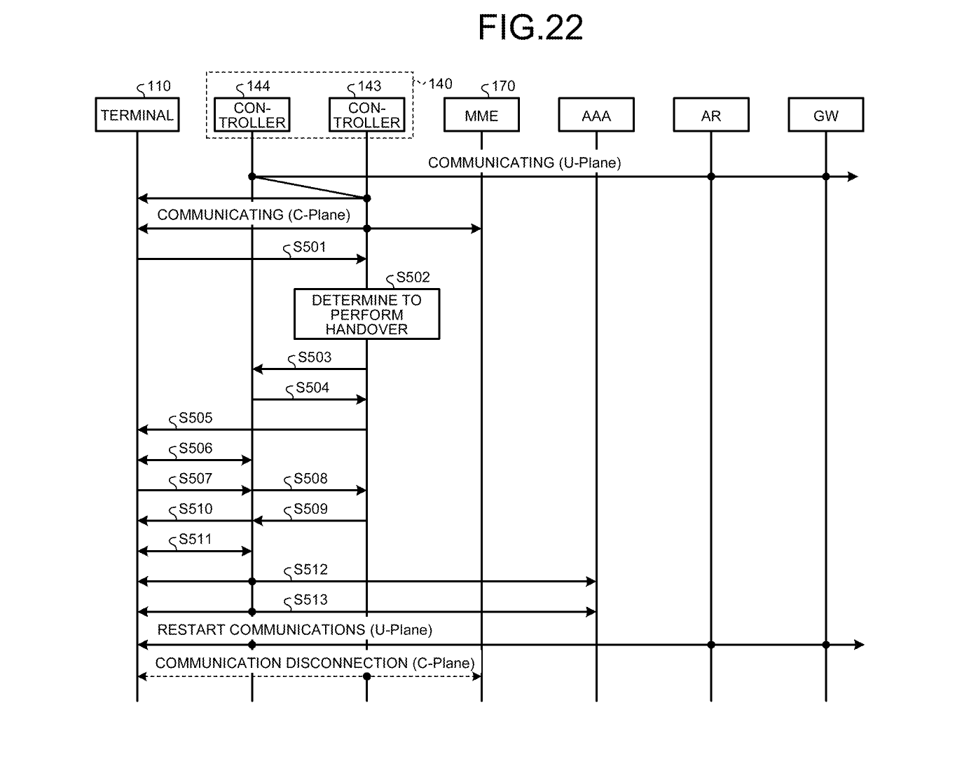

FIG. 22 is a diagram for explaining an inter-device handover procedure (variation 3). FIG. 22 particularly illustrates a procedure on inter-device handover from the fourth communication route to the second communication route. In other words, according to FIG. 22, the fourth communication route has been established and the U-plane uses the fourth communication route. The C-plane uses the route between the terminal 110, the controller 143 of the base station 140, the BBNW, and the MME. The C-plane route may be classified into the first communication route.

When a set condition is met, the terminal 110 transmits a measurement report to the controller 143 of the base station 140 by using the first radio section (step S501). The set condition may be, for example, a condition that, according to the measurement, the radio environment of the first radio section is better than that of the second radio section. The measurement report triggers the controller 143 of the base station 140 to determine to perform handover.

On the basis of the contents of the received measurement report and the amount of traffic of the network, the controller 143 of the base station 140 determines (judges) whether to perform handover (step S502). It is here assumed that the controller 143 determines to perform handover.

The controller 143 notifies the controller 144 that he controller 143 has determined to perform handover (step S503).

The controller 144 prepares for handover in response to the notification and, upon completing the preparation, outputs a response to the notification to the controller 143 (step S504).

The controller 143 transmits the handover instruction to the terminal 110 via the first radio section (step S505).

Upon receiving the handover instruction, the baseband processing controller 113 of the terminal 110 transfers the handover instruction to the baseband processing controller 114. The baseband processing controller 114 scans a beacon transmitted from the base station 140 in the frequency band usable in the wireless LAN system (step S506)

On the basis of the received beacon, the baseband processing controller 114 then transmits an authentication request to the controller 144 of the base station 140 by using the second radio section (step S507).

The controller 144 of the base station 140 then outputs the received authentication request to the controller 143 (step S508).

In response to the received authentication request, the controller 143 outputs an authentication method to the controller 144 (step S509).

The controller 144 then notifies the terminal 110 of the received authentication method by using the second radio section (step S510).

The baseband processing controller 114 of the terminal 110 and the controller 144 of the base station 140 establish an association (step S511).

The baseband processing controller 114 of the terminal 110 transmits the authentication request to the base station 140 in accordance with the notified authentication method by using the second radio section and, based on the received authentication request, the controller 144 of the base station 140 accesses the AAA (step S512).

The AAA then transmits the authentication check to the terminal 110 via the controller 144 of the base station 140 (step S513).

In this manner, it is possible to switch from the fourth communication route to the second communication route. There is no C-plane.

As described above, according to the second embodiment, even when the 3GPP network serves as the first network and the wireless LAN servers as the second network, it is possible to acquire the same effects as those of the first embodiment.

### Other Embodiments

The components of each unit illustrated in the drawings according to the first and second embodiments are not necessarily configured physically as illustrated in the drawings. In other words, specific modes of distribution and integration of each unit are not limited to those illustrated in the drawings, and all or part of the units may be configured by functional or physical distribution or integration per arbitrary unit in accordance with various loads, the usage, etc.

All or part of various processing functions implemented by each device may be implemented in a central processing unit (CPU) (or a microcomputer, such as a micro processing unit (MPU) or a micro controller unit (MCU)). All or arbitrary part of the various processing functions may be implemented by a program that is analyzed and executed by the CPU (or a microcomputer such as a MPU or a MCU) or by a hard-wired logic.

The terminal, the base station, and the network apparatus according to the second embodiment may be implemented by, for example, the following hardware configuration.

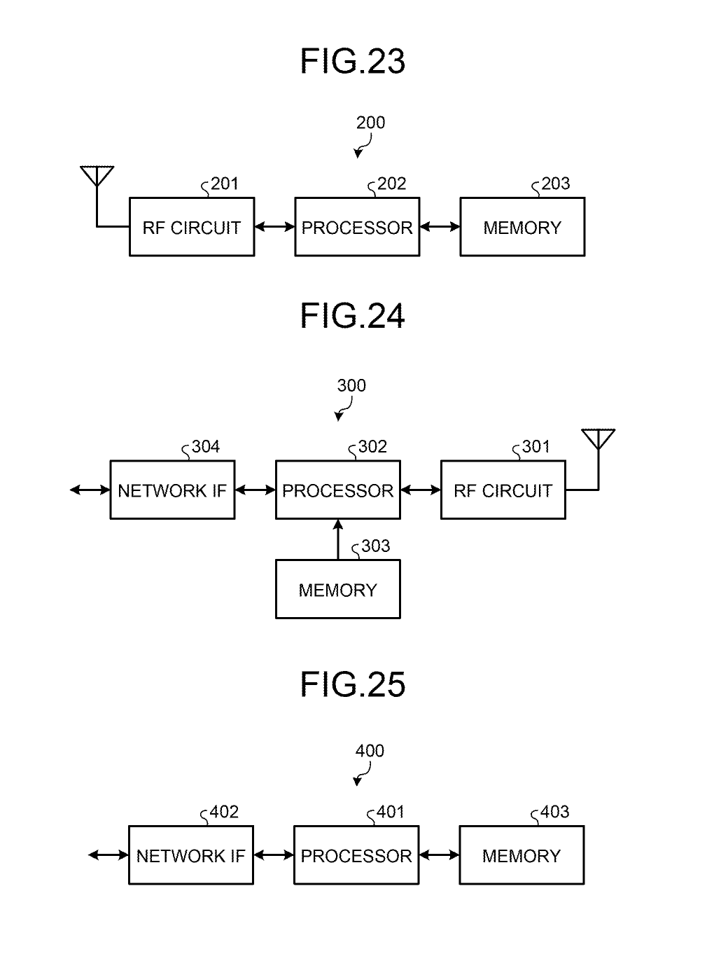

FIG. 23 is a diagram illustrating an exemplary hardware configuration of a terminal. As illustrated in FIG. 23, a terminal 200 includes a radio frequency (RF) circuit 201, a processor 202, and a memory 203.

As examples of the processor 202, there are a central processing unit (CPU), a digital signal processor (DSP), a field programmable gate array (FPGA), etc. As examples of the memory 203, there are a synchronous dynamic random access memory (SDRAM), a random access memory (RAM), a read only memory (ROM), and a flash memory.

Various processing functions implemented by the terminals according to the first and second embodiments may be implemented by a processor of an amplification device by executing programs stored in various memories, such as non-volatile storage media. In other words, programs corresponding to the controllers 13 and 14, the baseband processing controllers 113 and 114, and the application processing controller 115 may be stored in the memory 203 and each of the programs may be executed by the processor 202. The processes executed by the baseband processing controllers 113 and 114 and the application processing controller 115 may be allocated to and executed by multiple processors, such as the baseband CPU, the application CPU, etc. Furthermore, the processes executed by the controllers 13 and 14, the baseband processing controllers 113 and 114, and the application processing controller 115 may be allocated to and executed by separate processors. The radio unit 11, 12, 111, and 112 are implemented by the RF circuit 201.

FIG. 24 is a diagram illustrating an exemplary hardware configuration of a base station. As illustrated in FIG. 24, a base station 300 includes an RF circuit 301, a processor 302, a memory 303, and a network IF (interface) 304. As examples of the processor 302, there are a CPU, a DSP, a FPGA, etc. As examples of the memory 303, there are a RAM, such as a SDRAM, a ROM, a flash memory, etc.

Various processing functions implemented by the base stations according to the first and second embodiments may be implemented by a processor of an amplification device by executing programs stored in various memories, such as non-volatile storage media. In other words, programs corresponding to processes executed by the controllers 43, 44, 143 and 144, the baseband processors 147 and 148, and the switch 149 may be recorded in the memory 303 and each of the programs may be executed by the processor 302. The network IFs 45, 46, 145, and 146 are implemented by the network IF 304. The radio units 41, 42, 141, and 142 are implemented by the RF circuit 301.

The base station 300 has been described as a single base station. Alternatively, for example, the base station 300 may be configured of two separate devices that are a radio device and a control device. In this case, for example, the RF circuit 301 is disposed in the radio device and the processor 302, the memory 303, and the network IF 304 is disposed in the control devices.

FIG. 25 is a diagram illustrating an exemplary hardware configuration of a network apparatus. As illustrated in FIG. 25, a network apparatus 400 includes a processor 401, a network IF 402, and a memory 403. As examples of the processor 401, there are a CPU, a DSP, a FPGA, etc. As examples of the memory 403, there are a RAM, such as a SDRAM, a ROM, a flash memory, etc.

Various processing functions implemented by the network apparatuses according to the first and second embodiments may be implemented by a processor of the amplification device by executing programs stored in various memories, such as non-volatile storage media. In other words, programs corresponding to processed executed by the controllers 71 and 171 may be stored in the memory 403 and each of the programs may be executed by the processor 401. Furthermore, the network IFs 72 and 172 are implemented by the network IF 402.

According to the disclosed modes, it is possible to implement flexible traffic control on multiple networks.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station device comprising:
a first controller that connects a first network and a first radio section corresponding to a first communication system each other; and
a second controller that connects a second network and a second radio section corresponding to a second communication system each other,
wherein, when a given condition is met, the second controller transfers a signal received from a radio terminal device via the second radio section to the first network via the first controller.

2. The base station device according to claim 1, wherein the first controller and the second controller switches between a first mode in which the transfer is performed and a second mode in which the first controller receives a signal from the radio terminal device via the first radio section and transmits the signal, received via the first radio section, to the first network.

3. A radio terminal device comprising:
a first controller that generates a control signal corresponding to a first network;
a second controller that adds, to the control signal generated by the first controller, a header used in a second communication system corresponding to a second network; and
a radio unit that transmits the control signal added with the header to a base station device by using the second communication system.

4. A communication method comprising:
first connecting a first network and a first radio section corresponding to a first communication system each other, by a first controller;
second connecting a second network and a second radio section corresponding to a second communication system each other, by a second controller; and
transferring, when a given condition is met, a signal received from a radio terminal device via the second radio section to the first network via the first controller, by the second controller.
